(19) United States
(12) Patent Application Publication
(10) Pub. No.: US 2026/0318890 A1
(43) Pub. Date: Oct. 15, 2026

(54) METHOD FOR CROSS-SCALE PROCESS DEVELOPMENT OF A SEPARATION PROCESS

(71) Applicant: GLOBAL LIFE SCIENCES SOLUTIONS GERMANY GMBH, Dassel (DE)

(72) Inventors: Tobias Hahn, Dassel (DE); Tatjana Trunzer, Dassel (DE); Lena Enghauser, Dassel (DE)

(21) Appl. No.: 19/481,038

(22) PCT Filed: Apr. 24, 2024
(86) PCT No.: PCT/EP2024/061214

§ 371 Date: Nov. 3, 2025

(30) Foreign Application Priority Data
May 4, 2023 (SE) 2350543-1

(51) Int. Cl. G01N 30/86; B01D 15/10; G01N 30/02

(52) U.S. Cl. CPC G01N 30/8662; B01D 15/102; G01N 30/8693; G01N 2030/027

(57) ABSTRACT

A method for optimizing at least one process parameter of a separation process of at least one target substance from at least one impurity using a chromatography system, the method comprising the following steps: a) providing a set of preliminary system-specific parameters suitable for describing a concentration transport for the at least one target substance and the at least one impurity in a preliminary chromatography system using a system-specific transport model, wherein the preliminary chromatography system does not comprise any chromatography column but comprises a column shortcut; b) providing a set of preliminary column-specific parameters suitable for describing the concentration transport for the at least one target substance and the at least one impurity only in a preliminary chromatography column comprising a preliminary chromatography matrix using a column-specific transport model; c) determining a set of sorption-specific parameters suitable for describing the adsorption and/or desorption of the at least one target substance and the at least one impurity to or from the preliminary chromatography matrix comprised in the preliminary chromatography column using a sorption model, the set of preliminary system-specific parameters, and the set of preliminary column-specific parameters, wherein the preliminary chromatography system comprises the preliminary chromatography column of step b) instead of the column shortcut of step a); d) providing a set of system-specific parameters suitable for describing the concentration transport for the at least one target substance and the at least one impurity in the chromatography system using the system-specific transport model, wherein the chromatography system does not comprise any chromatography column but comprises a column shortcut; e) providing a set of column-specific parameters suitable for describing the concentration transport for the at least one target substance and the at least one impurity only in the chromatography column comprising a chromatography matrix using the column-specific transport model; f) in silico optimizing the at least one process parameter using the following parameters: the set of system-specific parameters of step d), the set of column-specific parameters of step e), and the set of sorption-specific parameters of step c), wherein the chromatography system comprises the chromatography column of step e) instead of the column shortcut of step d), wherein the sum of the volume of the chromatography system not comprising any chromatography column and the volume of the chromatography column differs from the sum of the volume of the preliminary chromatography system not comprising any chromatography column and the volume of the preliminary chromatography column.

### TECHNICAL FIELD

The invention relates to a method for optimizing a separation process of a target substance from an impurity using a chromatography system.

### BACKGROUND

Chromatography, in particular liquid chromatography plays an important role in the downstream bioprocessing of target substances, especially when it comes to the purification of therapeutic proteins, antibiotics, hormones (e.g., insulin and human growth hormone), blood products, antibodies, vaccines, enzymes, nucleic acids, viruses, viral vectors, virus-like particles, cells, natural fragrance, and flavor compounds, nutritional proteins. Liquid chromatography separation techniques provide mild conditions, which are advantageous for such sensitive molecules. Furthermore, chromatography separation techniques provide a variety of possible interaction modes rendering them applicable for a wide range of separation problems. Furthermore, chromatographic separation techniques have a long history in industry and regulatory authorities. Hence, they are widely spread and common to use. The global chromatography market size was valued at $8,706 million in 2020 and expected to reach $15,339 million by 2030.

Downstream bioprocessing involves complex set-ups of different separation steps, including chromatography steps. Hence, it is a desire to optimize such set-ups to achieve the highest possible purity and yield. Particularly, chromatography steps involved in downstream bioprocessing have been topic of such considerations. As optimizing includes running multiple test processes, optimizing a chromatography set-up in industrial scale affords unreasonably high amounts of material such as matrix, dilute, tracers, target substance and test molecules as well as working time due to long running times. Hence, the well-established solution to this problem is to optimize a chromatography set-up on a laboratory scale followed by a scale up of this optimized process to industrial production scale. To further minimize the need for material and time, it has been established over the last years to shift as much as possible of the optimizing work for such set-ups to virtual environments, such as in-silico simulations.

Although scaling up requires fewer runs than optimizing, the process of scaling up the laboratory scale optimized results to industrial scale involves experimental runs of the industrial scale system. Hence, scaling up a liquid chromatography separation process from laboratory scale to industrial scale still has the disadvantage of being time consuming and expensive, as chromatography columns used in industrial scale have a volume of up to hundreds of liters involving respectively large amounts of material such as matrix, dilute, tracers, target substance, and test molecules.

Scaling up is usually achieved in a linear fashion by increasing the column diameter while keeping other parameters such as the bed height, flow velocity, and the ratio of dilute volumes to column bed volume applied during different phases of the process (loading, elution, washing) constant. However, chromatographic columns in industrial scale can usually only be obtained in discrete sizes regarding the diameter. Thus, the linear scaling up approach has the further disadvantage of less flexibility. In order to address this lack of flexibility a scaling process based on a constant contact time (residence time), is proposed (cf. Hansen, E. B., “Chromatographic Scale-Up on a Volume Basis.” Preparative Chromatography for Separation of Proteins, 2017, https://doi.org/10.1002/9781119031116.ch7), which introduces the column bed height as a process design variable rather than a fixed parameter. Since the bed height is a continuous variable, as opposed to the diameter, it can be used to obtain exactly the volume needed in any scale. However, such an approach again introduces complexity of the scaling-up process.

A third disadvantage of the approach to optimize on laboratory scale and scaling up to industrial scale is that the optimization of the separation process is not performed on the industrial scale. It is well known that at larger scales the process performance, i.e., separation efficiency, typically improves due to relatively small dead volumes. However, this positive effect is not precisely predictable when using an experimental workflow for process development. As a result, the scaled-up process is often over-optimized as regards purity and, as a consequence, produces sub-optimal results as regards yield.

In view of these problems, it has been shown that cross-scale quality assessment of chromatographic separation using mechanistic modeling is feasible (cf. Saleh D et al., “Cross-scale quality assessment of a mechanistic cation exchange chromatography model”, Biotechnology Prog. 2021, 37(1):e3081, doi:10.1002/btpr.3081).

### SUMMARY OF THE INVENTION

However, still the scaling procedure on an industrial production scale has to be performed in particular in experiment, leading to the requirement of large amounts of material and time as outlined above, less flexibility and error prone results.

Hence it is an object of the invention to provide a method for cross-scale process development, where the optimization of a chromatographic process is performed directly on the desired scale without the need of prior optimization on laboratory scale.

It has now been surprisingly found that the above-mentioned object has been achieved by a method for optimizing at least one process parameter of a separation process of at least one target substance from at least one impurity using a chromatography system, the method comprising the following steps:
a) providing a set of preliminary system-specific parameters suitable for describing a concentration transport for the at least one target substance and the at least one impurity in a preliminary chromatography system using a system-specific transport model, wherein the preliminary chromatography system does not comprise any chromatography column but comprises a column shortcut;
b) providing a set of preliminary column-specific parameters suitable for describing the concentration transport for the at least one target substance and the at least one impurity only in a preliminary chromatography column comprising a preliminary chromatography matrix using a column-specific transport model;
c) determining a set of sorption-specific parameters suitable for describing the adsorption and/or desorption of the at least one target substance and the at least one impurity to or from the preliminary chromatography matrix comprised in the preliminary chromatography column using a sorption model, the set of preliminary system-specific parameters, and the set of preliminary column-specific parameters, wherein the preliminary chromatography system comprises the preliminary chromatography column of step b) instead of the column shortcut of step a);
d) providing a set of system-specific parameters suitable for describing the concentration transport for the at least one target substance and the at least one impurity in the chromatography system using the system-specific transport model, wherein the chromatography system does not comprise any chromatography column but comprises a column shortcut;
e) providing a set of column-specific parameters suitable for describing the concentration transport for the at least one target substance and the at least one impurity only in the chromatography column comprising a chromatography matrix using the column-specific transport model;
f) in silico optimizing the at least one process parameter using the following parameters: the set of system-specific parameters of step d), the set of column-specific parameters of step e), and the set of sorption-specific parameters of step c), wherein the chromatography system comprises the chromatography column of step e) instead of the column shortcut of step d),
wherein the sum of the volume of the chromatography system not comprising any chromatography column and the volume of the chromatography column differs from the sum of the volume of the preliminary chromatography system not comprising any chromatography column and the volume of the preliminary chromatography column.

This method surprisingly results in a faster process development, as the time-consuming steps of initial optimization in small scale can be neglected. Furthermore, less consumables such as single-use columns, resin, microtiter-plates, chemicals, or water are required for the process development, due to the optimization in step f) being performed in silico. Further need of consumables can be reduced, as the parameters of the preliminary chromatography system can be used for further separation problems, assuming equal transportation of target molecules and/or impurities. Generally, as tedious and time-consuming optimization experiments can be omitted, the method results in reduced labor time and thus in a more economical process development.

### DEFINITIONS

The term “process parameter” as used herein is a parameter having an influence on the separation process. Preferably, the process parameter is selected from the list consisting of the flow rate of at least one loading step, the pH value of a loading fluid, the temperature of a loading fluid, the conductivity of the loading fluid, the composition of the loading fluid, the amount of the at least one target substance bound to the chromatography matrix per volume of the chromatography column, the amount of the at least one impurity bound to a defined volume of the chromatography matrix, the concentration of the at least one target substance, the concentration of the at least one impurity in the loading fluid, and/or the duration of the at least one loading step, the flow rate of at least one washing step, the pH value of a washing fluid, the temperature of the washing fluid, the conductivity of the washing fluid, the composition of the washing fluid, the flow rate of at least one elution step, the duration of the at least one elution step, the initial or final concentration of an elution fluid which induces a desorption of the least one target substance and/or the least one impurity from the chromatography matrix of the chromatography column, and/or or the composition of the elution fluid.
The term “separation process” as used herein is a process that involves a stationary, preferably a chromatography matrix, and a mobile phase, preferably at least one solvent, for the separation of a target substance from an impurity. Preferably, the separation process is a chromatography process. Even more preferably, the separation process is a chromatography process selected from the list consisting of affinity chromatography, ion exchange chromatography, hydrophobic interaction chromatography, reversed phase chromatography, multimodal or mixed-mode chromatography.
The term “target substance” as used herein is a substance, which should be separated from a mixture of components comprising said target substance. Preferably, the target substance is a substance of biological origin or has been produced by a biological process or is intended to be used in a biological environment. More preferably, the target substance is selected from the list consisting of therapeutic proteins, antibiotics, hormones (e.g., insulin and human growth hormone), blood products, antibodies, vaccines, enzymes, nucleic acids, viruses, viral vectors, virus-like particles, cells, natural fragrance, and flavor compounds, nutritional proteins. Most preferably, the at least one target substance is a polypeptide.
The term “impurity” as used herein denotes a substance that decreases the purity of the target substance. Preferably, the at least one impurity is a polypeptide.
The term “column shortcut” as used herein denotes a device having a low dead volume. Preferably, the column shortcut is a zero dead volume connector. However, the column shortcut may also be a tubing or two connected column endpieces. It should be understood that the dead volume of the column shortcut depends on the scale of the system. Hence, usually, a column shortcut in a laboratory scale system has a lower dead volume than a column shortcut in an industrial scale system. However, more preferably, the column shortcut has a dead volume in the range of from 0.00001 to 100 mL, more preferably in the range of from 0.0001 to 10 mL, even more preferably in the range of from 0.001 to 0.5 mL, and most preferably in the range of from 2 to 5 μL.
The term “chromatography system” as used herein denotes a system comprising a pump, a first tubing, and a chromatography column or a column shortcut, wherein the first tubing fluidly connects the pump with the chromatography column or the column shortcut. Preferably, the chromatography system further comprises a second tubing and a detector and/or fraction collector, wherein the second tubing fluidly connects the column or the column shortcut with the detector and/or fraction collector. The chromatography system usually implements input and output streams by connecting respective vessels by tubing to the pump and/or the detector. The chromatography system may further comprise at least one valve and/or at least one bubble trap and or at least one mixing chamber. Exemplary chromatography systems are ÄKTA start, ÄKTA go, ÄKTA pure, ÄKTA avant, ÄKTA pilot, or ÄKTA ready available by Cytiva.
The term “unit” denotes a device comprised in the chromatography system, wherein different units of the chromatography system are usually connected by tubing. Preferably, the unit is selected from the list consisting of a chromatography column, a column shortcut, a detector, a fraction collector, a valve, a bubble trap, or a mixing chamber.
The term “preliminary chromatography system” as used herein denotes a chromatography system on which sorption-specific parameters suitable for describing the adsorption and/or desorption of a target substance and at least one impurity are determined.
The term “detector” as used herein may be any device suitable for detecting substances in a fluid passing the device. Preferably, the detector is selected from the list consisting of an ultraviolet light absorption (UV) detector, a visible light absorption (VIS) detector, a photo diode array (PDA) detector, a refractive-index detector, an evaporative light scattering detector, a multi-angle light scattering detector, a mass spectrometer, a conductivity detector, a fluorescence detector, a chemiluminescence detector, an optical rotation detector, and an electrochemical detector. Preferably the detector is located downstream of the column.
The term “volume of the chromatography system” as used herein denotes the system internal volume of the chromatography system. The system internal volume is the sum of volumes of units comprised in the chromatography system.
The term “delay volume” as used herein denotes a dead volume in the system that causes a shift in the x-axis (time or volume) of a sensor signal without changing the shape of the sensor signal. In particular, no mixing or dispersion effects are assumed to occur in delay volumes.
The term “chromatography column” as used herein denotes a device for the separation of substances comprising a chromatography matrix as stationary phase.
The term “interaction” as used herein denotes an attraction of at least two structural units, wherein the attraction is based on chemical and/or physical principles. Preferably, the interaction is selected from the list consisting of ionic interaction, hydrophobic interaction, preferably ionic interaction and hydrophobic interaction, moiety-specific interaction, hydrogen-bonding interaction, or combinations thereof.
The term “chromatography matrix” denotes the stationary phase in a chromatography separation process. Preferably, the chromatography matrix is suitable for an interaction with a target substance and/or at least one impurity. More preferably, the chromatography matrix comprises at least one active moiety that interacts by one or more physical or chemical interactions with the target substance and/or the impurity. The chromatography matrix may be fibrous, monolithic, membranous, or particular. Preferably, the chromatography matrix is a compound selected from the list consisting of natural polymers and/or synthetic polymers, preferably a compound selected from the list consisting of polysaccharides, polystyrene, polyacrylamide, polymethacrylate, or mixtures thereof.
The term “in silico” as used herein denotes a process that is carried out by means of computer modelling or computer simulation.
The term “fitting” as used herein denotes a process of constructing a mathematical function that has the best fit to a series of data points, such as data points measured by the detector in form of a measured chromatogram. Preferably, the term fitting denotes finding the parameter values of the mathematical function that minimize the sum of the squared differences of the data points and the values obtained by evaluating the mathematical function at the same coordinates as the data points. (e.g., by ordinary least squares).
The term “porous material” as used herein denotes a material comprising micro pores. Preferably, the term porous material denotes a material having micro pores, wherein any mass-transport process into and out of these pores is diffusion dominated, i.e., with negligible influence of convective mass-transport.
The term “micro pores” as used herein denotes cavities in the surface of a material, which prevent a convective flow of a fluid through the material. More preferably micro pores have a diameter of larger than or equal to 2 nm and smaller than or equal to 50 nm. Due to the small pore size, the mass-transport of the target substance and/or the impurity within the micro pores of the porous material is diffusion dominated, whereas convective mass-transport is hampered.
The term “tracer” as used herein denotes a substance, which can be processed in a chromatography system, and which can be detected by a detector. Preferably, the tracer does not interact with any component of the chromatography system, for example by means of adsorption. Preferably, the tracer is soluble in the mobile phase of the chromatography system. Depending on the size of the tracer, the influence of pores on the mass-transport in the chromatography matrix can be described. Hence, preferably a non-bulky tracer is chosen to determine the influence of pores on the mass-transfer, preferably micro pores in a porous material, on the separation process.

Thereby, the term “non-bulky tracer” as used herein denotes a tracer, which has a size suitable for penetrating the pores of a stationary phase, preferably chromatography matrix, wherein the chromatography matrix preferably comprises, more preferably consists of, a porous material.
The term “dextran” as used herein denotes a large polymer of anhydroglucose having a molecular weight in the range of from 3 kDa to 5 MDa. Dextrans having a molecular weight of more than or equal to 2 MDa are not able to penetrate the micro pores of chromatography matrix comprising, preferably consisting of, a porous material.
The term “active moiety” as used herein denotes a molecule or substance that interacts by one or more physical or chemical interactions with the target substance and/or the impurity. Preferably, the active moiety is selected from the list consisting of sulfopropyl, diethylaminoethyl, diethylaminopropyl, diethyl-(2-hydroxy-propyl)aminoethyl, octylamine, N-benzyl-n-methyl ethanolamine, methyl sulfonate, quarternary ammonium, carboxymethyl, alkyl, preferably octyl, hexyl, butyl, phenyl, bi-phenyl, pentafluorophenyl, phenyl-hexyl, ethyl, benzyl, or isopropyl, silanol, peptides, nucleotides, protein, an immunoglobulin binding protein, preferably protein A, protein G, protein L, metal ions, preferably cations of Cu, Ni, Co, Zn, nitrilotriacetic acid, domain antibody or domain antibody fragment, CHT, poly deoxythymidine (e.g. 25 mer for dT), C4, C6, C8, C10, C12, C14, C16, octadecyl carbon (C18), C20, C22, C24, heparin, dextran sulphate, 2-mercaptopyridine, hydroxylapatite, fluoroapatite, or combinations thereof.
The term “moiety-specific interaction”, also known as affinity interaction, as used herein denotes a specific interaction between the target substance and/or the impurity, and an interaction partner in form of the active moiety. Preferably, the target molecule/and or impurity binds specifically to the active moiety. The moiety specific interaction is preferably selected from the following: an interaction between an enzyme as target substance and/or impurity with a substrate analogue as moiety, an interaction between an antigen as target substance and/or impurity with an antibody as moiety, an interaction between a polysaccharide as target substance and/or impurity with a lectin as moiety, an interaction between a complementary base sequence as target substance and/or impurity with a nucleic acid as moiety, an interaction between a hormone receptor as target substance and/or impurity with a hormone as moiety, an interaction between biotin or biotin-conjugated substance, preferably a biotin-conjugated protein, as target substance and/or impurity with avidin as moiety, an interaction between a calmodulin binding partner as target substance and/or impurity with calmodulin as moiety, an interaction between a glutathione S-transferase fused substance, preferably a glutathione S-transferase fused protein, as target substance and/or impurity with glutathione as moiety, an interaction between an immunoglobulin as target substance and/or impurity with an immunoglobulin binding substance, preferably an immunoglobulin binding protein as moiety, an interaction between a polyhistidine fused substance, preferably a polyhistidine fused protein, as target substance and/or impurity with a complex of a metal cation binding protein as moiety

### DETAILED DESCRIPTION

The present invention is directed to a method for optimizing at least one process parameter of a separation process. The invention will be described in more detail in the following.

The present invention relates to a method for optimizing at least one process parameter of a separation process of at least one target substance from at least one impurity using a chromatography system, the method comprising the following steps: a) providing a set of preliminary system-specific parameters suitable for describing a concentration transport for the at least one target substance and the at least one impurity in a preliminary chromatography system using a system-specific transport model, wherein the preliminary chromatography system does not comprise any chromatography column but comprises a column shortcut; b) providing a set of preliminary column-specific parameters suitable for describing the concentration transport for the at least one target substance and the at least one impurity only in a preliminary chromatography column comprising a preliminary chromatography matrix using a column-specific transport model; c) determining a set of sorption-specific parameters suitable for describing the adsorption and/or desorption of the at least one target substance and the at least one impurity to or from the preliminary chromatography matrix comprised in the preliminary chromatography column using a sorption model, the set of preliminary system-specific parameters, and the set of preliminary column-specific parameters, wherein the preliminary chromatography system comprises the preliminary chromatography column of step b) instead of the column shortcut of step a); d) providing a set of system-specific parameters suitable for describing the concentration transport for the at least one target substance and the at least one impurity in the chromatography system using the system-specific transport model, wherein the chromatography system does not comprise any chromatography column but comprises a column shortcut; e) providing a set of column-specific parameters suitable for describing the concentration transport for the at least one target substance and the at least one impurity only in the chromatography column comprising a chromatography matrix using the column-specific transport model; f) in silico optimizing the at least one process parameter using the following parameters: the set of system-specific parameters of step d), the set of column-specific parameters of step e), and the set of sorption-specific parameters of step c), wherein the chromatography system comprises the chromatography column of step e) instead of the column shortcut of step d), wherein the sum of the volume of the chromatography system not comprising any chromatography column and the volume of the chromatography column differs from the sum of the volume of the preliminary chromatography system not comprising any chromatography column and the volume of the preliminary chromatography column.

The surprising technical effect of carrying out the optimization in step f) in combination with the requirement that the sum of the volume of the chromatography system not comprising any chromatography column and the volume of the chromatography column differs from the sum of the volume of the preliminary chromatography system not comprising any chromatography column and the volume of the preliminary chromatography column is, that it allows a process optimization directly at the desired scale. This inter alia solves the problem of over-optimization of purity and, as a consequence, sub-optimal yields as achieved with the optimization and scaling-up methods known from the prior art. Furthermore, the fact that the optimization is carried out in silico helps to optimize the chromatography system independently of the availability of chromatography columns having a discrete diameter. Hence, in the method according to the present invention, the diameter of the chromatography column can be finely-grained chosen in comparison to the optimization and scaling-up methods known from the prior art.

Preferably, the volume of the chromatography system not comprising any chromatography column differs from the volume of the preliminary chromatography system not comprising any chromatography column and/or the volume of the chromatography column differs from the volume of the preliminary chromatography column, preferably wherein only the volume of the chromatography column differs from the volume of the preliminary chromatography column.

Preferably, the volume of the chromatography system not comprising any chromatography column is larger, preferably 10 to 100000 times larger, and more preferably 100 to 70000 times larger, and most preferably 1000 to 10000 times larger, than the volume of the preliminary chromatography system not comprising any chromatography column and/or wherein the volume of the chromatography column is larger, preferably 10 to 100000 and more preferably 100 to 10000 times larger, and most preferably 1000 to 5000 times larger, than the volume of the preliminary chromatography column. More preferably, the volume of the chromatography system comprising the chromatography column is in the range of from more than 1.5 l to 1000 l, preferably from 13 l to 800 l, and the volume of the preliminary chromatography system comprising the preliminary chromatography column is in the range of from 0.0003 l to 1.5 l, preferably 0.001 l to 1.0 l. This ensures that the chromatography system is at a larger scale than the preliminary chromatography system, preferably the chromatography system is at industrial scale.

### Step a)

Preferably in step a) the set of preliminary system-specific parameters comprises, preferably consists of, a preliminary system internal dispersion (D_{ax_pre_sys}) and/or, preferably and, a preliminary system mixing rate (MR_{pre_sys}) of the preliminary chromatography system, wherein the preliminary chromatography system does not comprise any chromatography column but comprises a column shortcut. More preferably, the set of preliminary system-specific parameters comprises, preferably consists of, a preliminary tubing internal dispersion (D_{ax_pre_tub}) and one preliminary unit mixing rate (MR_{pre_unt}) per each unit comprised in the preliminary chromatography system. Most preferably, the set of preliminary system-specific parameters further comprises a preliminary system delay volume of the preliminary chromatography system, wherein the preliminary chromatography system does not comprise any chromatography column but comprises a column shortcut (DV_{pre_sys}). The preliminary system delay volume is in particular useful, if the information in view of the tubing is not fully descriptive.

In a first preferred embodiment of the method of the present invention, step a) comprises, preferably consists of, the following steps:
aa) measuring at least one measured preliminary system-specific chromatogram of a tracer in the preliminary chromatography system, wherein the preliminary chromatography system does not comprise any chromatography column but comprises a column shortcut;
ab) determining the preliminary system internal dispersion (D_{ax_pre_sys}) and/or, preferably and, the preliminary system mixing rate (MR_{pre_sys}), preferably determining the preliminary tubing internal dispersion (D_{ax_pre_tub}) and one preliminary unit mixing rate (MR_{pre_unt}) per each unit comprised in the preliminary chromatography system on basis of the at least one measured preliminary system-specific chromatogram;
   and wherein the tracer is not interacting with any component of the chromatography system.

The preliminary tubing internal dispersion (D_{ax_pre_tub}) may range of from 0.0001 mm²/s to 1000 mm²/s, preferably 0.001 mm²/s to 100 mm²/s and most preferably from 0.1 mm²/s to 10 mm²/s.

As the tracer is not interacting with any component of the chromatography system the resulting chromatogram is not influenced by adsorptive mechanisms and reflects only the mixing and dispersive effects within the chromatography system.

Preferably, step ab) of the first preferred embodiment of the invention comprises, preferably consists of, the step of determining the preliminary system internal dispersion (D_{ax_pre_sys}) and/or, preferably and, the preliminary system mixing rate (MR_{pre_sys}), preferably determining the preliminary tubing internal dispersion (D_{ax_pre_tub}) and one preliminary unit mixing rate (MR_{pre_unt}) per each unit comprised in the preliminary chromatography system, by fitting a simulated preliminary system-specific chromatogram resulting from the system-specific transport model to the at least one measured preliminary system-specific chromatogram, wherein the system-specific transport model comprises the preliminary system internal dispersion (D_{ax_pre_sys}) and preliminary system mixing rate (MR_{pre_sys}), preferably comprises the preliminary tubing internal dispersion (D_{ax_pre_tub}) and one preliminary unit mixing rate (MR_{pre_unt}) per each unit comprised in the preliminary chromatography system, as a parameter and wherein the system-specific transport model describes the preliminary chromatography system, wherein the preliminary chromatography system does not comprise any chromatography column but comprises a column shortcut.

Preferably, the system-specific transport model of step ab) of the first preferred embodiment of the present invention comprises, preferably consists of, at least one continuously stirred tank reactor (CSTR) model and/or at least one dispersed plug flow reactor (DPFR) model.

The CSTR model is a common model for a chemical reactor in chemical engineering and environmental engineering. The mathematical model works for liquids, gases, and slurries and can be used as a tool for modelling the mixing of a substance with a fluid in compartments of a chromatography system such as bubble traps or mixing chambers by means of the mixing rate MR.

The DPFR model describes the dispersion of a substance in a fluid in tubular compartments of a chromatography system such as tubing or hoses by means of the effective dispersion coefficient Dax.

Preferably, the fitting of step ab) of the first preferred embodiment of the invention is carried out by adjusting the preliminary system internal dispersion (D_{ax_pre_sys}) and/or preliminary system mixing rate (MR_{pre_sys}), preferably adjusting the preliminary tubing internal dispersion (D_{ax_pre_tub}) and one preliminary unit mixing rate (MR_{pre_unt}) per each unit comprised in the preliminary chromatography system, as the parameter of the system-specific transport model until the simulated preliminary system-specific chromatogram fits the at least one measured preliminary system-specific chromatogram. Preferably, the measured preliminary system-specific chromatogram is measured by injection of the tracer into the preliminary chromatography system and subsequent measurement of the concentration of the tracer downstream the column shortcut. Preferably, the measurement of the concentration of the tracer is carried out by ultraviolet light spectroscopy, visible light spectroscopy, near infrared spectroscopy, refractive-index measurement, mass spectrometry, conductivity measurement, fluorescence spectrometry, chemiluminescence spectrometry, and/or electrochemistry. Preferably, the tracer is selected from the group of dextrans, preferably dextrans having a molecular weight of equal to or higher than 2 MDa, glucose, acetone, chlorides, the at least one target substance, the at least one impurity, a protein, a peptide, nanoparticles, preferably metal nanoparticles and more preferably gold nanoparticles.

It should be understood that the choice of the tracer of step aa) of the first preferred embodiment of the invention depends on the choice of the preliminary chromatography system. The tracer should have low or no interactions with any unit or tubing of the preliminary chromatography system. As no preliminary chromatography column is comprised in the preliminary chromatography system according to the first preferred embodiment of the present invention, the interaction between the tracer and a preliminary chromatography matrix can be neglected in this embodiment.

### Step b)

Preferably, the column-specific transport model of step b) is selected from the list consisting of an ideal model, equilibrium dispersive model, a transport dispersive model, lumped rate model, lumped kinetic model, a general rate model, or combinations thereof.

The ideal model takes into account only convective transport and assumes a permanently established local equilibrium between mobile and stationary phases. Compared to the ideal model the equilibrium dispersive model additionally includes a term describing axial dispersion in the mass balance of the mobile phase. The transport dispersive model is characterized by a second parameter describing rate limitations apart from axial dispersion. This second parameter subdivides the models into those where either mass transport or kinetic terms are rate limiting. The lumped rate model summarizes the internal and external mass transfer resistance in one lumped transfer coefficient (keff). The lumped kinetic model considers that the adsorption kinetics are rate limiting. The general rate model incorporates in addition to the axial dispersion a minimum of two other parameters describing mass transport effects. These two parameters may combine mass transfer in the liquid film and inside the pores as well as surface diffusion and adsorption kinetics in various kinds. More information on these models can be found in “Preparative Chromatography”, edited by Henner Schmidt-Traub (ISBN 978-3-527-34486-4).

In a second preferred embodiment of the present invention the set of preliminary column-specific parameters of step b) comprises, preferably consists of, the preliminary column axial dispersion (D_{ax_pre_col}) and/or, preferably and, the preliminary column interstitial porosity (ε_{p_pre_col}),
wherein step b) comprises, preferably consists of, the following steps:
ba) measuring at least one measured preliminary column-specific chromatogram of a tracer in the preliminary chromatography system, wherein the preliminary chromatography system comprises the preliminary chromatography column of step b) instead of the column shortcut of step a);
bb) determining the preliminary column axial dispersion (D_{ax_pre_col}) and/or, preferably and, the preliminary column interstitial porosity (ε_{p_pre_col}) on basis of the at least one measured preliminary column-specific chromatogram,
and wherein the tracer is not interacting with any component of the preliminary chromatography system or of the preliminary chromatography column.

Alternatively, preliminary column interstitial porosity (ε_{p_pre_col}) could be derived from the preliminary system pressure curve using the Kozeny-Carman equation.

Preferably, the step bb) of the second preferred embodiment of the present invention comprises, preferably consists of, determining the preliminary column axial dispersion (D_{ax_pre_col}) and/or, preferably and, the preliminary column interstitial porosity (ε_{p_pre_col}) by fitting of a simulated preliminary column-specific chromatogram resulting from the column-specific transport model to the at least one measured preliminary column-specific chromatogram, wherein the column-specific transport model comprises the preliminary column axial dispersion (D_{ax_pre_col}) and the preliminary column interstitial porosity (ε_{p_pre_col}) as parameters and wherein the column-specific transport model describes the preliminary chromatography column.

The preliminary column axial dispersion (D_{ax_pre_col}) may range of from 0.001 mm²/s to 100 mm²/s, preferably 0.01 mm²/s to 10 mm²/s and most preferably from 0.1 mm²/s to 1 mm²/s. The preliminary column interstitial porosity (ε_{p_pre_col}) may range of from 0 to 1, preferably 0.1 to 0.8 and most preferably from 0.2 to 0.7.

Preferably, the fitting of step bb) of the second preferred embodiment of the present invention is carried out by adjusting the preliminary column axial dispersion (D_{ax_pre_col}) and/or, preferably and, the preliminary column interstitial porosity (ε_{p_pre_col}) as parameter of the column-specific transport model until the simulated preliminary column-specific chromatogram fits the at least one measured preliminary column-specific chromatogram. Preferably, the at least one measured preliminary column-specific chromatogram is measured by injection of the tracer into the preliminary chromatography system and subsequent measurement of the concentration of the at least one tracer downstream of the preliminary chromatography column. Preferably, the measurement of the concentration of the at least one tracer is carried out by ultraviolet light spectroscopy, visible light spectroscopy, near infrared spectroscopy, refractive-index measurement, mass spectrometry, conductivity measurement, fluorescence spectrometry, chemiluminescence spectrometry, and/or electrochemistry. Preferably, the tracer is selected from the group of dextrans, preferably dextrans with a molecular weight of equal to or more than 2 MDa, glucose, acetone, sodium chloride, the at least one target substance, the at least one impurity, a protein, a peptide, nanoparticles, preferably metal nanoparticles and more preferably gold nanoparticles.

It should be understood that the choice of the tracer of step ba) of the second preferred embodiment of the invention depends on the choice of the preliminary chromatography system and the choice of the preliminary chromatography column, in particular the preliminary chromatography matrix. The tracer should have low or no interactions with any unit or tubing of the preliminary chromatography system including the preliminary chromatography matrix. Preferred combinations of preliminary chromatography matrices and tracers are dextrans with a molecular weight of equal to or more than 2 MDa for beads and NaCl for membranes or monoliths in the absence of any micro pores. Furthermore, the tracer should not be able to penetrate the porous material.

In a second especially preferred embodiment of the second preferred embodiment of the present invention, the preliminary chromatography matrix comprises, preferably consists of, a porous material, wherein the set of preliminary column-specific parameters further comprises the preliminary column total porosity (ε_{tot_pre_col}), the preliminary column effective mass transfer coefficient (k_{eff_pre_col}), and/or, preferably and, both, the preliminary column film transfer coefficient (k_{film_pre_col}) and the preliminary column pore diffusion coefficient (D_{p_pre_col}), and wherein step b) further comprises the following steps:
bc) measuring at least one measured preliminary matrix-specific chromatogram of a non-bulky tracer in the preliminary chromatography system comprising the preliminary chromatography column instead of the column shortcut of step a);
bd) determining the preliminary column total porosity (ε_{tot_pre_col}), the preliminary column effective mass transfer coefficient (k_{eff_pre_col}) and/or, preferably and, both, the preliminary column film transfer coefficient (k_{film_pre_col}) and the preliminary column pore diffusion coefficient (D_{p_pre_col}) on basis of the at least one measured preliminary matrix-specific chromatogram,
wherein the tracer is not able to penetrate the porous material of the preliminary chromatography matrix of the preliminary chromatography column;
wherein the non-bulky tracer is not interacting with any component of the preliminary chromatography system or the preliminary chromatography column,
wherein the non-bulky tracer is able to penetrate the porous material of the preliminary chromatography matrix of the preliminary chromatography column, and wherein step ba) and bc) can be performed simultaneously thereby providing a combined chromatogram comprising the preliminary column-specific chromatogram and the preliminary matrix-specific chromatogram, or sequentially thereby providing two distinct chromatograms of the preliminary column-specific chromatogram and the preliminary matrix-specific chromatogram.

The preliminary column total porosity (ε_{tot_pre_col}) may range of from 0 to 1, preferably 0.5 to 0.95 and most preferably from 0.6 to 0.9. The preliminary column effective mass transfer coefficient (k_{eff_pre_col}) may range of from 0.0001 mm/s to 10 mm/s, preferably 0.001 mm/s to 1 mm/s and most preferably from 0.001 mm/s to 0.01 mm/s. The preliminary column film transfer coefficient (k_{film_pre_col}) may range of from 0.0001 mm/s to 10 mm/s, preferably 0.001 mm/s to 1 mm/s and most preferably from 0.01 mm/s to 0.1 mm/s. The preliminary column pore diffusion coefficient (D_{p_pre_col}) may range of from 1×10⁻⁷ mm²/s to 0.01 mm²/s, preferably 1×10⁻⁶ mm²/s to 0.001 mm²/s, and most preferably from 1×10⁻⁵ mm²/s to 1×10⁻⁴ mm²/s.

Preferably, step bd) of the second especially preferred embodiment of the second preferred embodiment of the present invention comprises, preferably consists of, determining the preliminary column total porosity (ε_{tot_pre_col}), preliminary column effective mass transfer coefficient (k_{eff_pre_col}), and/or, preferably and, both, the preliminary column film transfer coefficient (k_{film_pre_col}) and the preliminary column pore diffusion coefficient (D_{p_pre_col}) by fitting a simulated preliminary matrix-specific chromatogram resulting from the column-specific transport model to the at least one measured preliminary matrix-specific chromatogram, wherein the column-specific transport model comprises the preliminary column axial dispersion (D_{ax_pre_col}), the preliminary column interstitial porosity (ε_{p_pre_col}) determined in step bb), the preliminary column total porosity (ε_{tot_pre_col}), preliminary column effective mass transfer coefficient (k_{eff_pre_col}), and/or, preferably and, both, the preliminary column film transfer coefficient (k_{film_pre_col}) and the preliminary column pore diffusion coefficient (D_{p_pre_col}) as parameters and wherein the column-specific transport model describes the preliminary chromatography column. Preferably, the at least one measured preliminary matrix-specific chromatogram is measured by injection of the non-bulky tracer into the preliminary chromatography system and subsequent measurement of the concentration of the non-bulky tracer downstream of the preliminary chromatography column. Preferably, the measurement of the concentration of the non-bulky tracer is carried out by ultraviolet light spectroscopy, visible light spectroscopy, near infrared spectroscopy, refractive-index measurement, mass spectrometry, conductivity measurement, fluorescence spectrometry, chemiluminescence spectrometry, and/or electrochemistry.

Alternatively, step bd) comprises the step of determining the preliminary column effective mass transfer coefficient (k_{eff_pre_col}), and/or, preferably and, both, the preliminary column pore diffusion coefficient (D_{p_pre_col}) and the preliminary column film transfer coefficient (k_{film_pre_col}) on the basis of already determined values and/or correlations taken from the literature.

Preferably, the fitting for the determination of the parameters in step bd) of the second especially preferred embodiment of the second preferred embodiment of the present invention is carried out by adjusting the preliminary column axial dispersion (D_{ax_pre_col}), the preliminary column interstitial porosity (ε_{p_pre_col}), the preliminary column total porosity (ε_{tot_pre_col}), the preliminary column effective mass transfer coefficient (k_{eff_pre_col}), and/or, preferably and, both, the preliminary column film transfer coefficient (k_{film_pre_col}) and the preliminary column pore diffusion coefficient (D_{p_pre_col}) as parameters of the column-specific transport model until the simulated preliminary matrix-specific chromatogram fits the at least one measured preliminary matrix-specific chromatogram.

Preferably, the non-bulky tracer of step bd) of the second especially preferred embodiment of the second preferred embodiment of the present invention is selected from the group of acetone, glucose, the at least one target substance, the at least one impurity, a protein, and a peptide.

It should be understood that the choice of the tracer of step ba) of the second especially preferred embodiment of the second preferred embodiment of the invention depends on the choice of the preliminary chromatography system and the choice of the preliminary chromatography column, in particular the preliminary chromatography matrix. The tracer should have low or no interactions with any unit or tubing of the preliminary chromatography system including the preliminary chromatography matrix. A preferred combination of preliminary chromatography matrix and tracer are dextrans with a molecular weight of equal to or more than 2 MDa for beads. Furthermore, the tracer should not be able to penetrate the porous material.

Likewise, it should be understood that the choice of the non-bulky tracer of step bc) of the second especially preferred embodiment of the second preferred embodiment of the invention depends on the choice of the preliminary chromatography system and the choice of the preliminary chromatography column, in particular the preliminary chromatography matrix. The non-bulky tracer should have low or no interactions with any unit or tubing of the preliminary chromatography system including the preliminary chromatography matrix. A preferred tracer is NaCl. However, the non-bulky tracer should be able to penetrate the porous material.

### Step c)

In a third preferred embodiment of the present invention, step c) comprises, preferably consists of, the following steps:
ca) measuring at least one measured preliminary target-specific chromatogram of the at least one target substance in the preliminary chromatography system, wherein the preliminary chromatography system comprises the preliminary chromatography column of step b) instead of the column shortcut of step a);
cb) measuring at least one measured preliminary impurity-specific chromatogram of the at least one measured impurity in the preliminary chromatography system, wherein the preliminary chromatography system comprises the preliminary chromatography column of step b) instead of the column shortcut of step a);
cc) determining the set of sorption-specific parameters on basis of the at least one measured preliminary target-specific chromatogram and the at least one measured preliminary impurity-specific chromatogram,
wherein step ca) and cb) can be performed simultaneously thereby providing a combined chromatogram comprising the target-specific chromatogram and the impurity-specific chromatogram, or sequentially thereby providing two distinct chromatograms of the target-specific chromatogram and the impurity-specific chromatogram.

In a first especially preferred embodiment of the third preferred embodiment of the present invention, step cc) comprises, preferably consists of, the following steps:
cca) determining the sorption-specific parameters of the target substance by fitting a simulated preliminary target-specific chromatogram for the at least one target substance in the preliminary chromatography system comprising the preliminary chromatography column of step b) instead of the column shortcut of step a) to the at least one measured preliminary target-specific chromatogram, wherein the simulated preliminary target-specific chromatogram results from
   the sorption model of step c), wherein the sorption model comprises the sorption-specific parameters of the target substance as parameters and wherein the sorption model describes the adsorption/desorption behaviour of the at least one target substance with the preliminary chromatography matrix comprised in the preliminary chromatography column;
   the system-specific transport model of step a); and
   the column-specific transport model of step b);
ccb) determining the sorption-specific parameters of the impurity by fitting a simulated preliminary impurity-specific chromatogram for the at least one impurity in the preliminary chromatography system comprising the preliminary chromatography column instead of the column shortcut of step a) to the at least one measured preliminary impurity-specific chromatogram, wherein the simulated preliminary impurity-specific chromatogram results from
   a sorption model of step c), wherein the sorption model comprises the sorption-specific parameters of the impurity as parameters and wherein the sorption model describes the adsorption/desorption behaviour of the at least one impurity with the preliminary chromatography matrix comprised in the preliminary chromatography column;
   the system-specific transport model of step a); and
   the column-specific transport model of step b);
wherein the set of sorption-specific parameters comprises, preferably consists of, the sorption-specific parameters of the target substance and sorption-specific parameters of the at least one impurity.

Preferably, in step cc) of the third preferred embodiment of the present invention the sorption-specific parameters of the at least one target substance comprise, preferably consist of, a preliminary equilibrium constant of the at least one target substance to the preliminary chromatography matrix (k_{eq_target}) and/or, preferably and, a preliminary kinetic constant of the at least one target substance from the preliminary chromatography matrix (k_{kin_target}).

Likewise, preferably, in step cc) of the third preferred embodiment of the present invention the sorption-specific parameters of the at least one impurity comprise, preferably consist of, a preliminary equilibrium constant of the at least one impurity to the preliminary chromatography matrix (k_{eq_imp}) and/or, preferably and, a preliminary kinetic constant of the at least one impurity from the preliminary chromatography matrix (k_{kin_imp}).

Preferably, the sorption model of step c) describes an interaction between the at least one target substance and the preliminary chromatography matrix, preferably the at least one active moiety comprised in the preliminary chromatography matrix, and an interaction between the at least one impurity and the preliminary chromatography matrix, preferably the at least one active moiety comprised in the preliminary chromatography matrix. Preferably, the interaction is selected from a list consisting of ionic interaction, hydrophobic interaction, preferably ionic interaction and hydrophobic interaction, moiety-specific interaction, hydrogen-bonding interaction, or combinations thereof.

In a second especially preferred embodiment of the third preferred embodiment of the present invention, the interaction is an ionic interaction, and the set of sorption-specific parameters further comprises an ionic capacity of the preliminary chromatography matrix comprised in the preliminary chromatography column, the set of sorption specific parameters of the target substance comprises a charge of the at least one target substance (V_{ads_target}), a steric shielding of the at least one target substance (σ_{ads_target}), and/or, preferably and, the lateral charge of the at least one target substance (Z_{lat_target}) and the set of sorption specific parameters of the at least one impurity comprises the charge of the at least one target substance (V_{ads_imp}), a steric shielding of the at least one target substance (σ_{ads_imp}), and/or, preferably and, a lateral charge of the at least one target substance (Z_{lat_imp}).

In a third especially preferred embodiment of the third preferred embodiment of the present invention, the interaction is a hydrophobic interaction, and the set of sorption-specific parameters of the target substance comprises an activity parameter K_{salt_target}, describing the change of the thermodynamic activity of the target substance due to the presence of salt ions, a stoichiometric parameter n_{i_target} describing the number of hydrophobic ligands that are occupied by the target substance, and/or, preferably and, q_{max, target}, a target substance specific saturation capacity, and the set of sorption specific-parameters of the impurity comprises an activity parameter K_{salt_imp}, describing the change of the thermodynamic activity of the impurity due to the presence of salt ions, a stoichiometric parameter n_{i_imp} describing the number of hydrophobic ligands that are occupied by the impurity and/or, preferably and, q_{max, imp}, an impurity specific saturation capacity.

In a fourth especially preferred embodiment of the third preferred embodiment of the present invention, the interaction is a hydrogen bonding interaction, and the set of sorption-specific parameters comprises parameters describing hydrogen-bonding interactions between the target substance and the preliminary chromatography matrix and/or, preferably and, a set of sorption-specific parameters describing hydrogen-bonding interactions between the impurity and the preliminary chromatography matrix.

In a fifth especially preferred embodiment of the third preferred embodiment of the present invention, the interaction is a combination of an ionic interaction, a hydrophobic interaction and/or, preferably and, a hydrogen-bonding interaction.

In a sixth especially preferred embodiment of the third preferred embodiment of the present invention, the interaction is a moiety-specific interaction, and the set of sorption-specific parameters further comprises a preliminary equilibrium constant of the at least one target substance describing the specific interaction of the target substance with a moiety comprised in the preliminary chromatography matrix (k_{eq_target_moiety)}, a preliminary kinetic constant of the at least one target substance describing the specific interaction of the target substance with a moiety comprised by the preliminary chromatography matrix (k_{kin_target_moiety}), a preliminary equilibrium constant of the at least one impurity describing the specific interaction of the impurity with a moiety comprised by the preliminary chromatography matrix (k_{eq_imp_moiety}), and/or, preferably and, a preliminary kinetic constant of the at least one impurity describing the specific interaction of the impurity with a moiety comprised by the preliminary chromatography matrix (k_{kin_imp_moiety}).

### Step D)

Preferably, the set of system-specific parameters in step d) comprises, preferably consists of, a system internal dispersion (D_{ax_sys}) and/or, preferably and, a system mixing rate (MR_{sys}) of the chromatography system, preferably a tubing internal dispersion (D_{ax_tub}) and one unit mixing rate (MRᵤₙₜ) per each unit comprised in the chromatography system, wherein the chromatography system does not comprise any chromatography column but comprises a column shortcut. Most preferably, the set of system-specific parameters further comprises a system delay volume of the chromatography system, wherein the chromatography system does not comprise any chromatography column but comprises a column shortcut (DV_{sys}). The system delay volume is in particular useful, if the tubing internal dispersion is not fully descriptive.

In a fourth preferred embodiment of the present invention, step d) comprises, preferably consists of, the following steps:
da) measuring at least one measured system-specific chromatogram of the tracer in the chromatography system wherein the chromatography system does not comprise any chromatography column but comprises a column shortcut;
db) determining the system internal dispersion (D_{ax_sys}) and/or, preferably and, the system mixing rate (MR_{sys}) of the chromatography system, preferably determining the tubing internal dispersion (D_{ax_tub}) and one unit mixing rate (MRᵤₙₜ) per each unit comprised in the chromatography system on basis of the at least one measured system-specific chromatogram;
and wherein the tracer is not interacting with any component of the chromatography system.

The tubing internal dispersion (D_{ax_tub}) may range of from 0.0001 mm²/s to 1000 mm²/s, preferably 0.001 mm²/s to 100 mm²/s and most preferably from 0.1 mm²/s to 10 mm²/s.

Preferably, step db) of the fourth preferred embodiment of the present invention comprises, preferably consists of, the step of determining the system internal dispersion (D_{ax_sys}) and/or, preferably and, the system mixing rate (MR_{sys}) of the chromatography system, preferably determining the tubing internal dispersion (D_{ax_tub}) and one unit mixing rate (MRᵤₙₜ) per each unit comprised in the chromatography system, by fitting a simulated system-specific chromatogram resulting from the system-specific transport model to the at least one measured system-specific chromatogram, wherein the system-specific transport model comprises the system internal dispersion (D_{ax_sys}) and/or, preferably and, the system mixing rate (MR_{sys}), preferably the tubing internal dispersion (D_{ax_tub}) and optionally one unit mixing rate (MRᵤₙₜ) per each unit comprised in the chromatography system, as parameter and wherein the system-specific transport model describes the chromatography system, wherein the chromatography system does not comprise any chromatography column but comprises a column shortcut.

Preferably, in step db) of the fourth preferred embodiment of the present invention the system-specific transport model comprises, preferably consists of, at least one continuously stirred tank reactor (CSTR) model and/or at least one dispersed plug flow reactor (DPFR) model.

The CSTR model is a common model for a chemical reactor in chemical engineering and environmental engineering. The mathematical model works for liquids, gases, and slurries and can be used as a tool for modelling the mixing of a substance with a fluid in compartments of a chromatography system such as bubble traps or mixing chambers by means of the mixing rate MR.

The DPFR model describes the dispersion of a substance in a fluid in tubular compartments of a chromatography system such as tubings or hoses by means of the effective dispersion coefficient Dax.

Preferably, the fitting of step db) of the fourth preferred embodiment of the present invention is carried out by adjusting the system internal dispersion (D_{ax_sys}) and/or, preferably and, the system mixing rate (MR_{sys}) of the chromatography system, preferably the tubing internal dispersion (D_{ax_tub}) and one unit mixing rate (MRᵤₙₜ) per each unit comprised in the chromatography system, as the parameter of the system-specific transport model until the simulated chromatogram fits the at least one measured system-specific chromatogram. Preferably, the measured system-specific chromatogram is measured by injection of the tracer into the chromatography system and subsequent measurement of the concentration of the tracer downstream the column shortcut. Preferably, the measurement of the concentration of the tracer is carried out by ultraviolet light spectroscopy, visible light spectroscopy, near infrared spectroscopy, refractive-index measurement, mass spectrometry, conductivity measurement, fluorescence spectrometry, chemiluminescence spectrometry, and/or electrochemistry. Preferably, the tracer is selected from the group of dextrans, preferably dextrans having a molecular weight of equal to or more than 2 Mda, glucose, acetone, chlorides, the at least one target substance, the at least one impurity, a protein, a peptide, nanoparticles, preferably metal nanoparticles and more preferably gold nanoparticles.

It should be understood that the choice of the tracer of step da) of the fourth preferred embodiment of the invention depends on the choice of the chromatography system. The tracer should have low or no interactions with any unit or tubing of the chromatography system. As no chromatography column is comprised in the chromatography system according to the fourth preferred embodiment of the present invention, the interaction between the tracer and a chromatography matrix can be neglected in this embodiment.

### Step e)

Preferably, the column-specific transport model of step e) is selected from the list consisting of an ideal model, equilibrium dispersive model, a transport dispersive model, lumped rate model, lumped kinetic model, a general rate model, or combinations thereof.

Preferably, the chromatography matrix comprised in the chromatography column is suitable for same interactions as the preliminary chromatography matrix of the preliminary chromatography column of steps b) and c). More preferably, the chromatography matrix and the preliminary chromatography matrix each comprise an active moiety, whereas each active moiety allows for same interactions. Even more preferably, the chromatography matrix and the preliminary chromatography matrix each comprise the same active moiety. Also preferably, the chromatography matrix and the preliminary chromatography matrix comprise, preferably consists of, the same compound. Most preferably, the chromatography matrix and the preliminary chromatography matrix each comprise the same active moiety and the chromatography matrix and the preliminary chromatography matrix comprise, preferably consists of, the same compound.

In a fifth preferred embodiment of the present invention, the set of column-specific parameters comprises, preferably consists of, the column axial dispersion (D_{ax_col}) and/or, preferably and, the column interstitial porosity (ε_{p_col}), wherein step e) comprises, preferably consists of, the following steps:
ea) measuring at least one measured column-specific chromatogram of the tracer in the chromatography system, wherein the chromatography system comprises the chromatography column of step e) instead of the column shortcut of step d);
eb) determining the column axial dispersion (D_{ax_col}) and/or, preferably and, the column interstitial porosity (ε_{p_col}) on basis of the at least one measured column-specific chromatogram;
and wherein the tracer is not interacting with any component of the chromatography system or of the chromatography column.

Alternatively, column interstitial porosity (ε_{p_col}) could be derived from the system pressure curve using the Kozeny-Carman equation.

The column axial dispersion (D_{ax_col}) may range of from 0.001 mm²/s to 100 mm²/s, preferably 0.01 mm²/s to 10 mm²/s and most preferably from 0.1 mm²/s to 1 mm²/s. The column interstitial porosity (ε_{p_col}) may range of from 0 to 1, preferably 0.1 to 0.8 and most preferably from 0.2 to 0.7.

Preferably, the step eb) according to the fifth preferred embodiment of the present invention comprises, preferably consists of determining the column axial dispersion (D_{ax_col}) and/or, preferably and, the column interstitial porosity (ε_{p_col}) by fitting a simulated column-specific chromatogram resulting from the column-specific transport model of step e) to the at least one measured column-specific chromatogram, wherein the column-specific transport model comprises the column axial dispersion (D_{ax_col}) and/or, preferably and, the column interstitial porosity (ε_{p_col}) as parameters and wherein the column-specific transport model describes the chromatography column.

Preferably, the fitting of step eb) of the fifth preferred embodiment of the present invention is carried out by adjusting the column axial dispersion (D_{ax_col}) and/or, preferably and, the column interstitial porosity (ε_{p_col}) as parameter of the column-specific transport model of step e) until the simulated column-specific chromatogram fits the at least one measured column-specific chromatogram. Preferably, the at least one measured column-specific chromatogram is measured by injection of the tracer into the chromatography system and subsequent measurement of the concentration of at least one the tracer downstream of the chromatography column. Preferably, the measurement of the concentration of the non-bulky tracer is carried out by ultraviolet light spectroscopy, visible light spectroscopy, near infrared spectroscopy, refractive-index measurement, mass spectrometry, conductivity measurement, fluorescence spectrometry, chemiluminescence spectrometry, and/or electrochemistry. Preferably, the tracer is selected from the group of dextrans, preferably dextrans having a molecular weight of equal to or more than 2 Mda, glucose, acetone, sodium chloride, the at least one target substance, the at least one impurity, a protein, a peptide, nanoparticles, preferably metal nanoparticles and more preferably gold nanoparticles.

In a first especially preferred embodiment of the fifth preferred embodiment of the present invention, the chromatography matrix of the chromatography column comprises, preferably consists of, a non-porous material.

In a second especially preferred embodiment of the fifth preferred embodiment of the present invention, the chromatography matrix of the chromatography column comprises, preferably consists of, a porous material,
wherein the set of column-specific parameters further comprises a column total porosity (ε_{tot_col}), a column effective mass transfer coefficient (k_{eff_col}), and/or, preferably and, both, a column film transfer coefficient (k_{film_col}) and a column pore diffusion coefficient (D_{p_col}), and
wherein step e) further comprises the following steps:
ec) measuring at least one measured matrix-specific chromatogram of the non-bulky tracer in the chromatography system comprising the chromatography column of step e) instead of the column shortcut of step d);
ed) determining the column total porosity (ε_{tot_col}), the effective mass transfer coefficient (k_{eff_col}), and/or, preferably and, both, the column film transfer coefficient (k_{film_col}) and the column pore diffusion coefficient (D_{p_col}) on basis of the at least one measured matrix-specific chromatogram;
wherein the tracer is not able to penetrate the porous material of the chromatography matrix of the chromatography column;
wherein the non-bulky tracer is not interacting with any component of the chromatography system or the chromatography column,
wherein the non-bulky tracer is able to penetrate the porous material of the chromatography matrix of the chromatography column, and
wherein step ea) and ec) can be performed simultaneously thereby providing a combined chromatogram comprising the column-specific chromatogram and the matrix-specific chromatogram, or sequentially thereby providing two distinct chromatograms of the column-specific chromatogram and the matrix-specific chromatogram.

The column total porosity (ε_{tot_col}) may range of from 0 to 1, preferably 0.5 to 0.95 and most preferably from 0.6 to 0.9. The column effective mass transfer coefficient (k_{eff_col}) may range of from 0.0001 mm/s to 10 mm/s, preferably 0.001 mm/s to 1 mm/s and most preferably from 0.001 mm/s to 0.01 mm/s. The column film transfer coefficient (k_{film_col}) may range of from 0.0001 mm/s to 10 mm/s, preferably 0.001 mm/s to 1 mm/s and most preferably from 0.01 mm/s to 0.1 mm/s. The column pore diffusion coefficient (D_{p_col}) may range of from 1×10⁻⁷ mm²/s to 0.01 mm²/s, preferably 1×10⁻⁶ mm²/s to 0.001 mm²/s, and most preferably from 1×10⁻⁵ mm²/s to 1×10⁻⁴ mm²/s.

Preferably, step ed) of the second especially preferred embodiment of the fifth preferred embodiment of the present invention comprises, preferably consists of, the step of determining the column total porosity (ε_{tot_col}), the column effective mass transfer coefficient (k_{eff_col}), and/or, preferably and, both, the column film transfer coefficient (k_{film_col}) and the column pore diffusion coefficient (D_{p_col}) by fitting a simulated matrix-specific chromatogram resulting from the column-specific transport model to the at least one measured matrix-specific chromatogram, wherein the column-specific transport model comprises the column axial dispersion (D_{ax_col}) and the column interstitial porosity (ε_{p_col}) determined in step eb) and the column total porosity (ε_{tot_col}), the column effective mass transfer coefficient (k_{eff_col}), and/or, preferably and, both, the column film transfer coefficient (k_{film_col}), and the column pore diffusion coefficient (D_{p_col}) as parameters and wherein the column-specific transport model describes the chromatography column. Preferably, the at least one measured matrix-specific chromatogram is measured by injection of the non-bulky tracer into the chromatography system and subsequent measurement of the concentration of the second tracer downstream of the chromatography column. Preferably, the measurement of the concentration of the non-bulky tracer is carried out by ultraviolet light spectroscopy, visible light spectroscopy, near infrared spectroscopy, refractive-index measurement, mass spectrometry, conductivity measurement, fluorescence spectrometry, chemiluminescence spectrometry, and/or electrochemistry.

Alternatively, step ed) comprises the step of determining the column effective mass transfer coefficient (k_{eff_col}), and/or, preferably and, both, the column pore diffusion coefficient (D_{p_col}) and the column film transfer coefficient (k_{film_col}) on the basis of already determined values and/or correlations taken from the literature.

Preferably, the fitting for the determination of the parameters in step ed) of the second especially preferred embodiment of the fifth preferred embodiment of the present invention is carried out by adjusting the column total porosity (ε_{tot_col}), the column effective mass transfer coefficient (k_{eff_col}), and/or, preferably and, both, the column film transfer coefficient (k_{film_col}), and the column pore diffusion coefficient (D_{p_col}) as parameters of the column-specific transport model until the simulated matrix-specific chromatogram fits the at least one measured matrix-specific chromatogram.

Preferably, the non-bulky tracer of step ed) of the second especially preferred embodiment of the fifth preferred embodiment of the present invention is selected from the group of acetone, glucose, the at least one target substance, the at least one impurity, a protein, and a peptide.

It should be understood that the choice of the tracer of step ea) of the second especially preferred embodiment of the fifth preferred embodiment of the invention depends on the choice of the chromatography system and the choice of the chromatography column, in particular the chromatography matrix. The tracer should have low or no interactions with any unit or tubing of the chromatography system including the chromatography matrix. A preferred combination of a chromatography matrix and a tracer are dextrans with a molecular weight of equal to or more than 2 MDa for beads. Furthermore, the tracer should not be able to penetrate the porous material.

Likewise, it should be understood that the choice of the non-bulky tracer of step ec) of the second especially preferred embodiment of the fifth preferred embodiment of the invention depends on the choice of the chromatography system and the choice of the chromatography column, in particular the chromatography matrix. The non-bulky tracer should have low or no interactions with any unit or tubing of the chromatography system including the chromatography matrix. A preferred tracer is NaCl. However, the non-bulky tracer should be able to penetrate the porous material.

### Step f)

In a sixth preferred embodiment of the present invention, step f) comprises the step of optimizing the at least one process parameter in silico by at least one optimization algorithm with respect to at least one objective function.

Preferably, the step of optimizing of the sixth preferred embodiment of the present invention comprises, preferably consists of, the step of adjusting the at least one process parameter by the optimization algorithm until the objective function reaches an extremum, preferably a minimum or a maximum.

Preferably, the at least one process parameter optimized by the method according to the present invention is used in the sixth preferred embodiment of the present invention as an input parameter for a model comprising the set of system-specific parameters of step d), the set of column-specific parameters of step e), and the set of sorption-specific parameters of step c), wherein the model output provides an input for the objective function. Preferably, the model output is a chromatogram.

Preferably, the at least one objective function of the step of optimizing of the sixth preferred embodiment of the present invention represents at least one performance criterion of the separation process. Preferably, the performance criterion is selected from the list consisting of a purity of the least one target substance, a recovery of the least one target substance, a dilution of the least one target substance, a duration of the separation process, a productivity of the separation process, a volume of at least one collected fraction of the at least one target substance, and/or an at least one impurity after passing the chromatography column.

Preferably, the optimization algorithm of the step of optimizing of the sixth preferred embodiment of the present invention is a heuristic optimization algorithm or a deterministic optimization algorithm. Preferably, the heuristic optimization algorithm is selected from the list consisting of annealing and genetic algorithm. Preferably, the deterministic optimization algorithm is selected from the list consisting of steepest descent and Levenberg-Marquardt simulated.

In a first especially preferred embodiment of the sixth preferred embodiment of the present invention, the separation process comprises at least one loading step in which a loading fluid comprising the least one target substance and the least one impurity is applied to the chromatography column by the chromatography system and in which the least one target substance and/or the least one impurity binds to the chromatography matrix of the chromatography column by adsorption. Preferably, the at least one process parameter is the flow rate of the at least one loading step, the pH value of the loading fluid, the conductivity of the loading fluid, the composition of the loading fluid, the amount of the at least one target substance bound to the chromatography matrix per volume of the chromatography column, the amount of the least one impurity bound to a defined volume of the chromatography matrix, the concentration of the least one target substance, the concentration of the at least one impurity in the loading fluid, and/or, preferably and, the duration of the at least one loading step.

In a second especially preferred embodiment of the sixth preferred embodiment of the present invention, the separation process further comprises at least one washing step in which a washing is applied to the chromatography column by the chromatography system after the at least one loading step fluid to remove the at least one target substance and/or the at least one impurity not bound to the chromatography matrix of the chromatography column from the chromatography column. Preferably, the at least one process parameter is the flow rate of the at least one washing step, the pH value of the washing fluid, the conductivity of the washing fluid, and/or, preferably and, the composition of the washing fluid.

In a third especially preferred embodiment of the sixth preferred embodiment of the present invention, the separation process further comprises at least one elution step, in which an elution fluid, which induces the desorption of the at least one target substance and/or the at least one impurity from the chromatography matrix of the chromatography column, is applied to the chromatography column of the chromatography system after the at least one loading step or the at least one washing step. Preferably, the desorption of the at least one target substance and/or the at least one impurity from the chromatography matrix of the chromatography column is induced by the pH value, the conductivity, composition, the concentration of at least one elution substance suitable for influencing the ad-or desorption of the at least one target substance, and/or the at least one impurity to or from the matrix of the chromatography column. Preferably, the at least one process parameter is the flow rate of the at least one elution step, the duration of the at least one elution step, the initial or final concentration of the elution fluid, the initial or final concentration of the at least one elution substance, and/or or the composition of the elution fluid. A preferred process parameter is the ratio of the concentrations of at least two elution substances.

In a seventh preferred embodiment of the present invention, at least one of the parameters of step a), step b), step d), and/or step e) is pre-determined.

In an eighth preferred embodiment of the present invention, step a) is step a) of the first preferred embodiment of the present invention, step b) is step b) of the second preferred embodiment of the present invention, step c) is step c) of the third preferred embodiment of the present invention, step d) is step d) of the fourth preferred embodiment of the present invention, step e) is step e) of the fifth preferred embodiment of the present invention, and step f) is step f) of the sixth preferred embodiment of the present invention.

In a ninth preferred embodiment of the present invention, step a) is step a) of the first preferred embodiment of the present invention, step b) is step b) of the second especially preferred embodiment of the second preferred embodiment of the present invention, step c) is step c) of the third preferred embodiment of the present invention, step d) is step d) of the fourth preferred embodiment of the present invention, step e) is step e) of the second especially preferred embodiment of the fifth preferred embodiment of the present invention, and step f) is step f) of the sixth preferred embodiment of the present invention.

In a tenth preferred embodiment of the present invention, the preliminary chromatography matrix of the preliminary chromatography column is a porous material and chromatography matrix of the chromatography column is a porous material.

In an eleventh preferred embodiment of the present invention, the preliminary chromatography matrix of the preliminary chromatography column is a non-porous material and the chromatography column is a non-porous material. A partial implementation of this eleventh preferred embodiment, including steps a), b), c), d) and e), is demonstrated in T. Hahn et al., “Predictive scaling of fiber-based protein A capture chromatography using mechanistic modelling”, Biotechnology and Bioengineering, 20 May 2023, pp. 1-12 (https://doi.org/10.1002/bit.28434). The content of this publication is further fully incorporated herein by reference to the maximum permissible extent allowed.

In a twelfth preferred embodiment of the present invention, the preliminary chromatography matrix of the preliminary chromatography column is a porous material and the chromatography column is a non-porous material.

In a thirteenth preferred embodiment of the present invention, the preliminary chromatography matrix of the preliminary chromatography column is a non-porous material and the chromatography column is a porous material.

1. A method for optimizing at least one process parameter of a separation process of at least one target substance from at least one impurity using a chromatography system, the method comprising the following steps:
a) providing a set of preliminary system-specific parameters suitable for describing a concentration transport for the at least one target substance and the at least one impurity in a preliminary chromatography system using a system-specific transport model, wherein the preliminary chromatography system does not comprise any chromatography column but comprises a column shortcut;
b) providing a set of preliminary column-specific parameters suitable for describing the concentration transport for the at least one target substance and the at least one impurity only in a preliminary chromatography column comprising a preliminary chromatography matrix using a column-specific transport model;
c) determining a set of sorption-specific parameters suitable for describing the adsorption and/or desorption of the at least one target substance and the at least one impurity to or from the preliminary chromatography matrix comprised in the preliminary chromatography column using a sorption model, the set of preliminary system-specific parameters, and the set of preliminary column-specific parameters, wherein the preliminary chromatography system comprises the preliminary chromatography column of step b) instead of the column shortcut of step a);
d) providing a set of system-specific parameters suitable for describing the concentration transport for the at least one target substance and the at least one impurity in the chromatography system using the system-specific transport model, wherein the chromatography system does not comprise any chromatography column but comprises a column shortcut;
e) providing a set of column-specific parameters suitable for describing the concentration transport for the at least one target substance and the at least one impurity only in the chromatography column comprising a chromatography matrix using the column-specific transport model;
f) in silico optimizing the at least one process parameter using the following parameters: the set of system-specific parameters of step d), the set of column-specific parameters of step e), and the set of sorption-specific parameters of step c), wherein the chromatography system comprises the chromatography column of step e) instead of the column shortcut of step d),
wherein the sum of the volume of the chromatography system not comprising any chromatography column and the volume of the chromatography column differs from the sum of the volume of the preliminary chromatography system not comprising any chromatography column and the volume of the preliminary chromatography column.

2. The method according to claim 1Error! Reference source not found. Error! Reference source not found., wherein the volume of the chromatography system not comprising any chromatography column is larger, preferably 10 to 100000 times larger, and more preferably 100 to 70000 times larger, and most preferably 1000 to 10000 times larger, than the volume of the preliminary chromatography system not comprising any chromatography column and/or wherein the volume of the chromatography column is larger, preferably 10 to 100000 and more preferably 100 to 10000 times larger, and most preferably 1000 to 5000 times larger, than the volume of the preliminary chromatography column, preferably, the volume of the chromatography system comprising the chromatography column is in the range of from more than 1.5 l to 1000 l, preferably from 13 l to 800 l , and the volume of the preliminary chromatography system comprising the preliminary chromatography column is in the range of from 0.0003 l to 1.5 l , preferably 0.001 l to 1.0 l.

3. The method claim 1, wherein in step a) the set of preliminary system-specific parameters comprises, preferably consists of, a preliminary system internal dispersion (D_{ax_pre_sys}) and/or a preliminary system mixing rate (MR_{pre_sys}) of the preliminary chromatography system, wherein the preliminary chromatography system does not comprise any chromatography column but comprises a column shortcut, and,
wherein step a) comprises, preferably consists of, the following steps:
aa) measuring at least one measured preliminary system-specific chromatogram of a tracer in the preliminary chromatography system, wherein the preliminary chromatography system does not comprise any chromatography column but comprises a column shortcut;
ab) determining the preliminary system internal dispersion (D_{ax_pre_sys}) and/or preliminary system mixing rate (MR_{pre_sys}) on basis of the at least one measured preliminary system-specific chromatogram;
and wherein the tracer is not interacting with any component of the chromatography system.

4. The method according to claim 1, wherein the set of preliminary column-specific parameters comprises, preferably consists of, the preliminary column axial dispersion (D_{ax_pre_col}) and/or the preliminary column interstitial porosity (ε_{p_pre_col}),
wherein step b) comprises, preferably consists of, the following steps:
ba) measuring at least one measured preliminary column-specific chromatogram of a tracer in the preliminary chromatography system, wherein the preliminary chromatography system comprises the preliminary chromatography column of step b) instead of the column shortcut of step a);
bb) determining the preliminary column axial dispersion (D_{ax_pre_col}) and/or the preliminary column interstitial porosity (ε_{p_pre_col}) on basis of the at least one measured preliminary column-specific chromatogram,
and wherein the tracer is not interacting with any component of the preliminary chromatography system or of the preliminary chromatography column.

5. The method according to claim 1Error! Reference source not found. Error! Reference source not found., wherein the preliminary chromatography matrix of the preliminary chromatography column comprises, preferably consists of, a porous material,
wherein the set of preliminary column-specific parameters further comprises the preliminary column total porosity (ε_{tot_pre_col}), the preliminary column effective mass transfer coefficient (k_{eff_pre_col}), and/or, both, the preliminary column film transfer coefficient (k_{film pre_col}) and the preliminary column pore diffusion coefficient (D_{p_pre_col}), and
wherein step b) further comprises the following steps:
bc) measuring at least one measured preliminary matrix-specific chromatogram of a non-bulky tracer in the preliminary chromatography system comprising the preliminary chromatography column instead of the column shortcut of step a);
bd) determining the preliminary column total porosity (ε_{tot_pre_col}), the preliminary column effective mass transfer coefficient (k_{eff_pre_col}) and/or, both, the preliminary column film transfer coefficient (k_{film_pre_ col}) and the preliminary column pore diffusion coefficient (D_{p_pre_col}) on basis of the at least one measured preliminary matrix-specific chromatogram,
wherein the tracer is not able to penetrate the porous material of the preliminary chromatography matrix of the preliminary chromatography column;
wherein the non-bulky tracer is not interacting with any component of the preliminary chromatography system or the preliminary chromatography column,
wherein the non-bulky tracer is able to penetrate the porous material of the preliminary chromatography matrix of the preliminary chromatography column, and
wherein step ba) and bc) can be performed simultaneously thereby providing a combined chromatogram comprising the preliminary column-specific chromatogram and the preliminary matrix-specific chromatogram, or sequentially thereby providing two distinct chromatograms of the preliminary column-specific chromatogram and the preliminary matrix-specific chromatogram.

6. The method according to claim 1, wherein step c) comprises, preferably consists of the following steps:
ca) measuring at least one measured preliminary target-specific chromatogram of the at least one target substance in the preliminary chromatography system, wherein the preliminary chromatography system comprises the preliminary chromatography column of step b) instead of the column shortcut of step a);
cb) measuring at least one measured preliminary impurity-specific chromatogram of the at least one measured impurity in the preliminary chromatography system, wherein the preliminary chromatography system comprises the preliminary chromatography column of step b) instead of the column shortcut of step a);
cc) determining the set of sorption-specific parameters on basis of the at least one measured preliminary target-specific chromatogram and the at least one measured preliminary impurity-specific chromatogram,
wherein step ca) and cb) can be performed simultaneously thereby providing a combined chromatogram comprising the target-specific chromatogram and the impurity-specific chromatogram, or sequentially thereby providing two distinct chromatograms of the target-specific chromatogram and the impurity-specific chromatogram.

7. The method according to claim 66, wherein step cc) comprises, preferably consists of, the following steps:
cca) determining the sorption-specific parameters of the target substance by fitting a simulated preliminary target-specific chromatogram for the at least one target substance in the preliminary chromatography system comprising the preliminary chromatography column of step b) instead of the column shortcut of step a) to the at least one measured preliminary target-specific chromatogram, wherein the simulated preliminary target-specific chromatogram results from
the sorption model of step c), wherein the sorption model comprises the sorption-specific parameters of the target substance as parameters and wherein the sorption model describes the adsorption/desorption behaviour of the at least one target substance with the preliminary chromatography matrix comprised in the preliminary chromatography column;
the system-specific transport model of step a); and
the column-specific transport model of step b);
ccb) determining the sorption-specific parameters of the impurity by fitting a simulated preliminary impurity-specific chromatogram for the at least one impurity in the preliminary chromatography system comprising the preliminary chromatography column instead of the column shortcut of step a) to the at least one measured preliminary impurity-specific chromatogram, wherein the simulated preliminary impurity-specific chromatogram results from
a sorption model of step c), wherein the sorption model comprises the sorption-specific parameters of the impurity as parameters and wherein the sorption model describes the adsorption/desorption behaviour of the at least one impurity with the preliminary chromatography matrix comprised in the preliminary chromatography column;
the system-specific transport model of step a); and
the column-specific transport model of step b);
wherein the set of sorption-specific parameters comprises, preferably consists of, the sorption-specific parameters of the target substance and sorption-specific parameters of the at least one impurity.

8. The method according to claim 7Error! Reference source not found., wherein the sorption-specific parameters of the at least one target substance comprise, preferably consist of, a preliminary equilibrium constant of the at least one target substance to the preliminary chromatography matrix (k_{eq_target}) and/or a preliminary kinetic constant of the at least one target substance from the preliminary chromatography matrix (k_{kin_target}).

9. The method according to claim ZError! Reference source not found. Error! Reference source not found., wherein the sorption-specific parameters of the at least one impurity comprise, preferably consist of, a preliminary equilibrium constant of the at least one impurity to the preliminary chromatography matrix (k_{eq_imp}) and/or a preliminary kinetic constant of the at least one impurity from the preliminary chromatography matrix (k_{kin_imp}).

10. The method according to claim 1, wherein in step d) the set of system-specific parameters comprises, preferably consists of, a system internal dispersion (D_{ax_sys}) and/or a system mixing rate (MR_{sys}) of the chromatography system, wherein the chromatography system does not comprise any chromatography column but comprises a column shortcut, and
wherein step d) comprises, preferably consists of, the following steps:
da) measuring at least one measured system-specific chromatogram of a tracer in the chromatography system wherein the chromatography system does not comprise any chromatography column but comprises a column shortcut;
db) determining the system internal dispersion (D_{ax_sys}) and/or the system mixing rate (MRsys) on basis of the at least one measured system-specific chromatogram
and wherein the tracer is not interacting with any component of the chromatography system.

11. The method according to claim 1, wherein the set of column-specific parameters comprises, preferably consists of, the column axial dispersion (D_{ax_col}) and/or the column interstitial porosity (ε_{p_col}),
wherein step e) comprises, preferably consists of, the following steps:
ea) measuring at least one measured column-specific chromatogram ofa tracer in the chromatography system, wherein the chromatography system comprises the chromatography column of step e) instead of the column shortcut of step d);
eb) determining the column axial dispersion (D_{ax_col}) and/or the column interstitial porosity (ε_{p_col}) on basis of the at least one measured column-specific chromatogram,
and wherein the tracer is not interacting with any component of the chromatography system or of the chromatography column.

12. The method according to claim 1, wherein the chromatography matrix of the chromatography column comprises, preferably consists of, a porous material,
wherein the set of column-specific parameters further comprises a column total porosity (ε_{tot_col}), a column effective mass transfer coefficient (K_{eff_col}), and/or, both, a column film transfer coefficient (k_{film_col}) and a column pore diffusion coefficient (D_{p_col}), and
wherein step e) further comprises the following steps:
ec) measuring at least one measured matrix-specific chromatogram of a non-bulky tracer in the chromatography system comprising the chromatography column of step e) instead of the column shortcut of step d);
ed) determining the column total porosity (ε_{tot_col}), the column effective mass transfer coefficient (k_{eff_col}), and/or, both, the column film transfer coefficient (k_{film_col}) and the column pore diffusion coefficient (D_{p_col}) on basis of the at least one measured matrix-specific chromatogram,
wherein the tracer is not able to penetrate the porous material of the chromatography matrix of the chromatography column;
wherein the non-bulky tracer is not interacting with any component of the chromatography system or the chromatography column,
wherein the non-bulky tracer is able to penetrate the porous material of the chromatography matrix of the chromatography column, and
wherein step ea) and ec) can be performed simultaneously thereby providing a combined chromatogram comprising the column-specific chromatogram and the matrix-specific chromatogram, or sequentially thereby providing two distinct chromatograms of the column-specific chromatogram and the matrix-specific chromatogram.

13. The method according to claim 1, wherein step f) comprises the step of optimizing the at least one process parameter in silico by at least one optimization algorithm with respect to at least one objective function,
wherein the step of optimizing comprises, preferably consists of, the step of adjusting the at least one process parameter by the optimization algorithm until the objective function reaches an extremum, preferably a minimum or a maximum.

14. The method according to claim 13Error! Reference source not found. Error! Reference source not found., wherein the at least one process parameter is used as an input parameter for a model comprising the set of system-specific parameters of step d), the set of column-specific parameters of step e), and the set of sorption-specific parameters of step c), wherein the model output, preferably a chromatogram, provides an input for the objective function.

15. The method according to claim 13, wherein the at least one objective function represents at least one performance criterion of the separation process, _{wherein the performance criterion is preferably selected from the list consisting of a purity of the least one target substance, a recovery of the least one target substance, a dilution of the least one target substance, a duration of the separation process, a productivity of the separation process, a volume of at least one collected fraction of the at least one target substance, and/or an at least one impurity after passing the chromatography column.}
